(19) United States
(12) Patent Application Publication
(10) Pub. No.: US 2026/0095545 A1
(43) Pub. Date: Apr. 2, 2026

(54) ENABLING REAL TIME MULTI-USER CONTENT COLLABORATION IN VIRTUAL MEETINGS

(71) Applicant: Google LLC, Mountain View, CA (US)

(72) Inventors: Bo Wang, Santa Clara, CA (US); Charles Patrick Reynolds, Durham, NC (US); Mai Truong Lowe, Durham, NC (US); Lixia Liu, Redmond, CA (US)

(21) Appl. No.: 18/902,654

(22) Filed: Sep. 30, 2024

(51) Int. Cl. H04N 7/15; G06Q 10/101

(52) U.S. Cl. CPC H04N 7/15; G06Q 10/101

(57) ABSTRACT

A method includes receiving, by a browser application, a first user interaction of a first participant of a virtual meeting to join the virtual meeting between the first participant and one or more other participants of the virtual meeting. The method further includes receiving, by the browser application and via a virtual meeting user interface (UI), a second user interaction of the first participant to share content of a first application within the virtual meeting. The method further includes causing information regarding the content of the first application to be transmitted to one or more client devices of the one or more other participants of the virtual meeting. The method further includes causing a first state of the content of the first application to be presented to the first participant and the one or more other participants of the virtual meeting.

### TECHNICAL FIELD

Aspects and implementations of the present disclosure relate to virtual meetings, and in particular to enabling real time multi-user content collaboration in virtual meetings.

### BACKGROUND

Virtual meeting systems allow individuals to communicate using digital means. Some virtual meeting systems allow individuals to communicate without being in the same physical location. Some virtual meeting systems allow individuals to communicate within the same physical location (e.g., lecture hall, auditorium, etc.). Some virtual meeting systems allow communication using text, audio data, and/or video data. Some virtual meeting systems can provide closed-captions and/or transcription services that use speech recognition to convert spoken conversation into text.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for enabling real time multi-user content collaboration in virtual meetings. In an implementation, a method includes receiving, by a browser application, a first user interaction of a first participant of a virtual meeting to join the virtual meeting between the first participant and one or more other participants of the virtual meeting. The method further includes receiving, by the browser application and via a virtual meeting user interface (UI), a second user interaction of the first participant to share first content of a first application within the virtual meeting. The method further includes causing information regarding the first content of the first application to be transmitted to one or more client devices of the one or more other participants of the virtual meeting. The method further includes causing a first state of the first content of the first application to be presented to the first participant and the one or more other participants of the virtual meeting.

In some embodiments, the method further includes receiving a second state of the first content of the first application from a second client device of a second participant of the one or more other participants of the virtual meeting. The second state reflects one or more changes to the first content by the second participant. The method further includes causing the second state of the first content of the first application to be presented to the first participant.

In some embodiments, the method further includes receiving, by the browser application, a third user interaction of the first participant to share second content of a second application within the virtual meeting. The method further includes causing information regarding the second content of the second application to be transmitted to the one or more client devices of the one or more other participants of the virtual meeting. The method further includes causing a first state of the second content of the second application to be presented within the virtual meeting UI.

In some embodiments, causing the first state of the first content of the first application to be presented to the first participant and the one or more other participants of the virtual meeting includes causing a visual representation of the first state of the first content of the first application to be transmitted to the one or more client devices of the one or more other participants of the virtual meeting.

In some embodiments, receiving the second user interaction of the first participant to share the first content of the first application within the virtual meeting includes presenting information related to a plurality of applications that facilitate content collaboration during the virtual meeting, receiving user selection of the first application from the plurality of applications, receiving user selection of the first content of the first application, and receiving user confirmation to grant access to the first content for the one or more other participants over a predefined time period.

In some embodiments, the method further includes receiving, by the browser application, heartbeat data of the first application within a first time period. The method further includes, responsive to failing to receive the heartbeat data within a second time period during the virtual meeting, causing a corrective action to be performed with respect to the first application.

In some embodiments, the first application includes at least one of a shared whiteboard application, a collaborative design application, a video game application, a collaborative document drafting application, a note taking application, or a remote technical support application.

In an implementation, a method includes receiving, by a browser application, a first user interaction of a first participant of a virtual meeting to join the virtual meeting between the first participant and one or more other participants of the virtual meeting. The method further includes receiving, by the browser application, an indication of content shared by a second participant of the one or more other participants of the virtual meeting via a first application within the virtual meeting. The method further includes receiving, by the browser application and via a virtual meeting user interface (UI), an input by the first participant to apply one or more changes to a first state of the content displayed in a frame of the virtual meeting UI. The frame of the virtual meeting UI can be associated with the first application. The method further includes causing a second state of the content to be transmitted to the one or more other participants. The second state can reflect the one or more changes to the content by the first participant.

In some embodiments, the method further includes, upon receiving the indication of the content shared by the second participant via the first application within the virtual meeting, determining whether the first application is present in a virtual meeting client running in the browser application. The method further includes, responsive to determining that the first application is present in the virtual meeting client running in the browser application, causing the first application to be associated with the frame of the virtual meeting UI.

In some embodiments, the method further includes, responsive to determining that the first application is not present in the virtual meeting client running in the browser application, determining whether the first application is compatible with the browser application. The method further includes, responsive to determining that the first application is compatible with the browser application, causing the first application to be associated with the frame of the virtual meeting UI.

In some embodiments, the method further includes receiving a third state of the content of the first application from a second client device of the second participant of the one or more other participants of the virtual meeting. The third state can reflect one or more changes to the content by the second participant. The method further includes causing the third state of the content of the first application to be presented to the first participant.

In some embodiments, the method further includes receiving, by the browser application, heartbeat data of the first application within a first time period. The method further includes, responsive to failing to receive the heartbeat data within a second time period during the virtual meeting, causing a corrective action to be performed with respect to the first application.

In some embodiments, the first application includes at least one of a shared whiteboard application, a collaborative design application, a video game application, a collaborative document drafting application, a note taking application, or a remote technical support application.

In some embodiments a computer-readable storage medium (which may be a non-transitory computer-readable storage medium, although the invention is not limited to that) stores instructions which, when executed, cause a processing device to perform operations comprising a method according to any embodiment or aspect described herein.

In some embodiments a system comprises: a memory device; and a processing device operatively coupled with the memory to perform operations comprising a method according to any embodiment or aspect described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system for enabling real time multi-user content collaboration in virtual meetings, in accordance with at least one embodiment.

FIG. 2A depicts a first view of a virtual meeting user interface, in accordance with one embodiment.

FIG. 2B depicts a second view of a virtual meeting user interface, in accordance with one embodiment.

FIG. 3 depicts a flow diagram of an example method for embedding applications in virtual meetings, in accordance with at least one embodiment.

FIG. 4 depicts a flow diagram of an example method for embedding applications in virtual meetings, in accordance with one embodiment.

FIG. 5 depicts a flow diagram of an example method for modifying content of an embedded application in a virtual meeting, in accordance with one embodiment.

FIG. 6 is a block diagram illustrating an exemplary computer system, in accordance with at least one embodiment of the present disclosure.

### DETAILED DESCRIPTION

Some virtual meeting systems can allow a participant of the virtual meeting to share content of one or more programs running on the participants device during the virtual meeting (e.g., “screen share”). In some cases, a participant can share a document of a web application, such as a note taking web application, a document drafting web application, or a design web application. However, sharing a document of the web application does not allow other participants to interact with the shared document directly in a virtual meeting user interface (UI), making the virtual meeting less interactive, efficient, and productive.

Aspects of the present disclosure address the above and other deficiencies by providing for real time (e.g., without delays and/or with negligible (e.g., milliseconds or microseconds) latency) multi-user content collaboration in virtual meetings. Real time (or near real time) multi-user collaboration in a virtual meeting refers to the ability for virtual meeting participants to make changes to content presented in virtual meeting UIs on their client devices and to view changes to content presented in virtual meeting UIs on their client devices as soon as (e.g., without delays and/or with negligible (e.g., milliseconds or microseconds) latency) these changes are made by other participants to the same content via the virtual meeting UIs on the other participants’ client devices. In some implementations, after initiating a virtual meeting in a browser application of a participant device, the participant can request that an application (e.g., web application ("web app")) and/or application content be added to (“embedded” in) the virtual meeting. Embedding an application or an application instance into a virtual meeting can refer to addition of an application instance to a virtual meeting client running in a browser application of a participant’s client device, causing the application and/or the application content, which can be interacted with by the participant, to be presented in a browser window designated for the virtual meeting UI.

In some implementations, the participant can share the content of the embedded application with other participants. In response, browser applications of the other participants’ client devices can invoke respective instances of the application, thereby allowing the participant and the other participants to collaborate on the application content within the virtual meeting UI on their respective client devices.

For example, a first participant can cause a document drafting application to be embedded within the virtual meeting and an editable document be opened via the document drafting application. A first state of the document opened via the document drafting application can be displayed within the virtual meeting UI for the first participant (e.g., on a device of the first participant) and for a second participant of the virtual meeting (e.g., on a device of the second participant). The second participant can interact with the document that is displayed within the virtual meeting UI on the second participant's device, and the first participant can see the changes made to the document by the second participant (a second state of the document) within the virtual meeting UI on the first participant's device.

In some embodiments, the embedded application (and/or application content) can be included in a primary (main) section of the virtual meeting UI. In some embodiments, the embedded application (and/or application content) can be included in a sidebar of the virtual meeting UI. In some embodiments, the embedded application (and/or application content) can be moved between a primary section of the virtual meeting UI and a sidebar of the virtual meeting UI during the virtual meeting. By including the embedded application within the virtual meeting UI, virtual meeting participants can work on a task (e.g., document drafting, note taking, etc.) while still being able to see other virtual meeting participants and their reactions. This can reduce the amount of time a user is switching from one tab of their browser application to another.

Advantages of the disclosed embodiments over the existing technology include but are not limited to improved client device resource utilization as the application can be embedded into a frame of the virtual meeting UI instead of running separately in its own tab or window of a browser application.

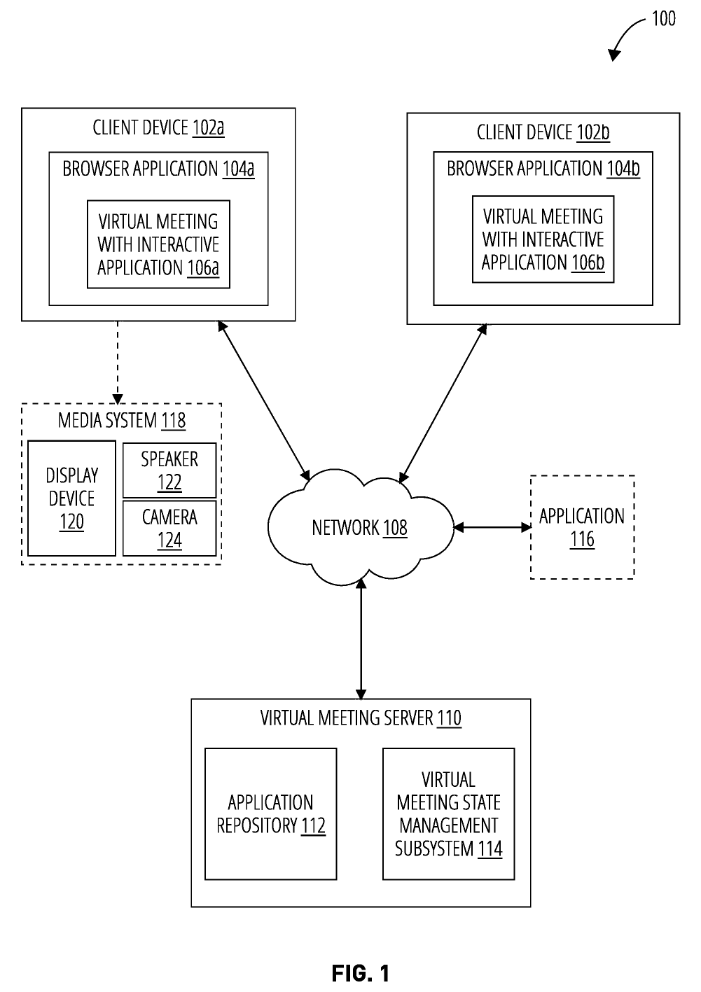

FIG. 1 illustrates an example system 100 for enabling real time multi-user content collaboration in virtual meetings, in accordance with at least one embodiment. System 100 can include one or more client devices 102a and 102b and virtual meeting server 110 connected via network 108, such as a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

Each client device (e.g., client device 102a, client device 102b, etc.) can correspond to a user and can enable the user to connect to an interface with virtual meeting server 110. Each client device (e.g., virtual meeting participant device) can include an audiovisual component that can generate audio and video data to be streamed to virtual meeting server 110. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a virtual meeting participant device. In some implementations, the audiovisual component includes an image capture device (e.g., a camera) to capture images and generate video data (e.g., a video stream) of the captured images.

In some embodiments, at least one of the virtual meeting participant devices is associated with a physical conference or meeting room and can include or be coupled to media system 118 that can include one or more display devices 120, one or more speakers 122, and one or more cameras 124. Display device 120 can be, for example, a smart display or a non-smart display (e.g., a display that is not itself configured to connect to the network). Users that are physically present in the room can use media system 118 rather than their own devices (e.g., one or more of devices 102a and 102b) to participate in the virtual meeting, which can include other remote users. For example, the users in the room that participate in the virtual meeting can control display device 120 to show a slide presentation or watch slide presentations of other participants. Sound and/or camera control can similarly be performed. The virtual meeting participant devices associated with a physical conference or meeting room can generate audio and video data to be streamed to virtual meeting server 110 (e.g., using one or more microphones, speakers, and/or cameras of the virtual meeting participant device).

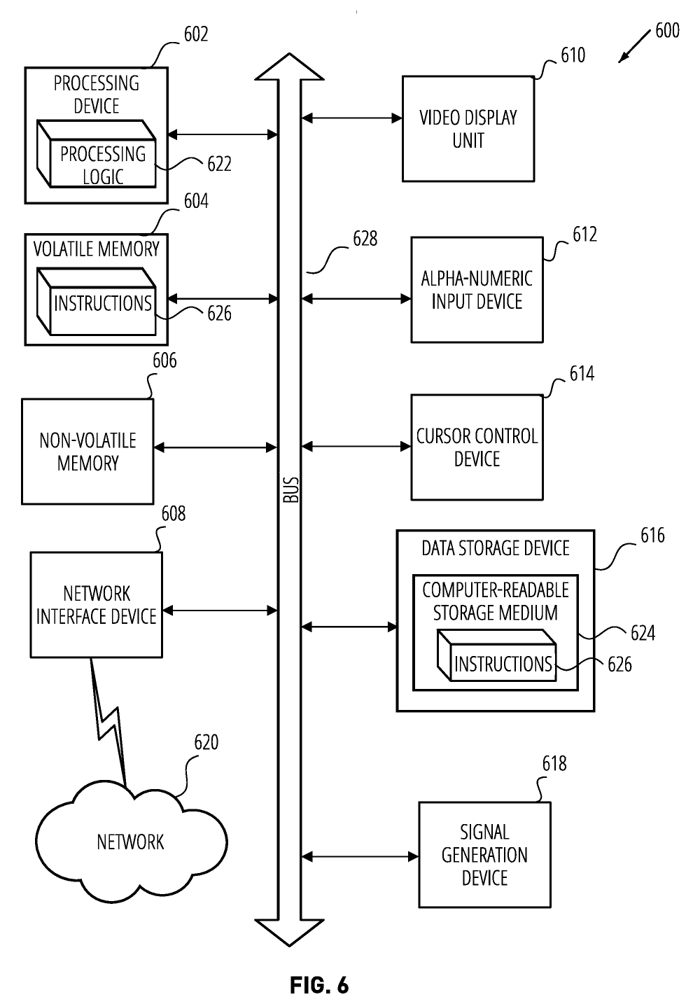

In some embodiments, client device 102a and/or client device 102b can include one or more processing devices, volatile and non-volatile memory, data storage, one or more input/output peripherals such as network interfaces. FIG. 6 illustrates an example architecture of computing devices. In some embodiments, client device 102a and/or client device 102b may be singular devices such as smartphones, tablets, laptops, desktops, workstations, edge devices, embedded devices, servers, network appliances, security appliances, etc. In some embodiments, client device 102a and/or client device 102b comprise multiple devices of similar or varying architecture such as computing clusters, data centers, co-located servers, enterprise networks, geographically disparate devices connected via virtual private networks (VPNs), etc. In some embodiments, client device 102a and/or client device 102b comprise hardware devices such as those just described, virtual resources such as virtual machines (VMs) and containerized applications, or a combination of hardware and virtual resources.

Each of client devices 102a and 102b can include a browser application (e.g., browser application 104a and browser application 104b) for connecting (e.g., via network 108) to applications (e.g., web sites, web application ("web apps"), etc.). For example, browser application 104a and browser application 104b can connect to a virtual meeting application that enables real time (or near real time) multi-user content collaboration in virtual meetings. For example, the virtual meeting application may allow participants to add another application to the virtual meeting (e.g., virtual meeting client (“virtual meeting”) with interactive application 106a, virtual meeting client (“virtual meeting”) with interactive application 106b). Virtual meeting with interactive application 106a and virtual meeting with interactive application 106b can include code that is executed by the browser application (e.g., browser application 104a, browser application 104b) and runs on the virtual meeting participants device (e.g., client device 102a, client device 102b). In some embodiments, the code for virtual meeting with interactive application 106a and/or virtual meeting with interactive application 106b is provided (e.g., via network 108) by virtual meeting server 110.

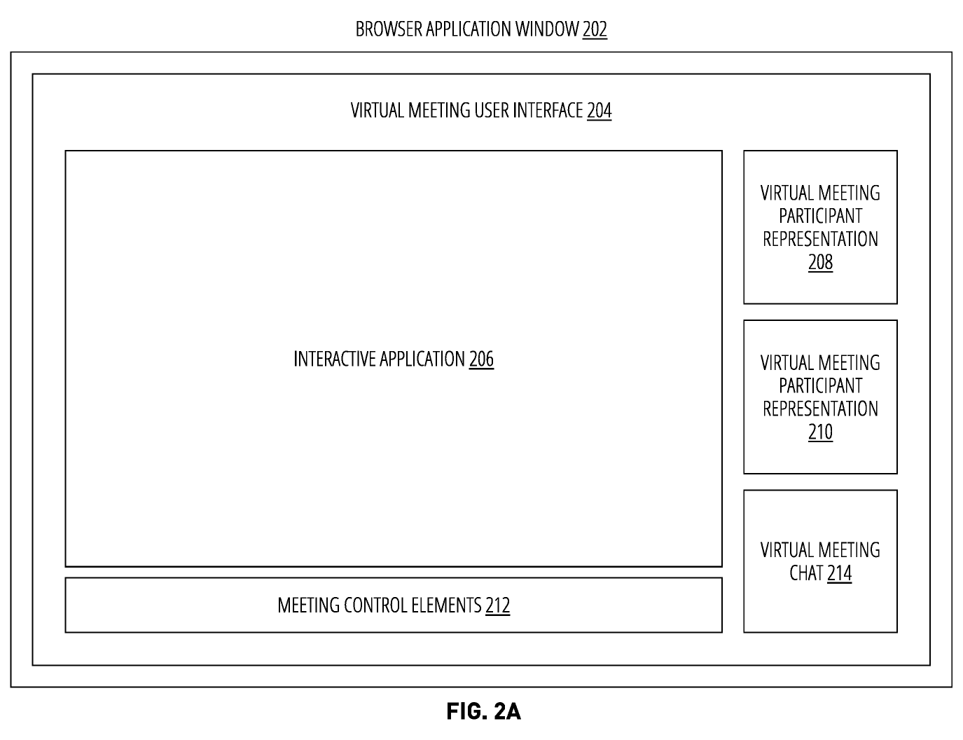

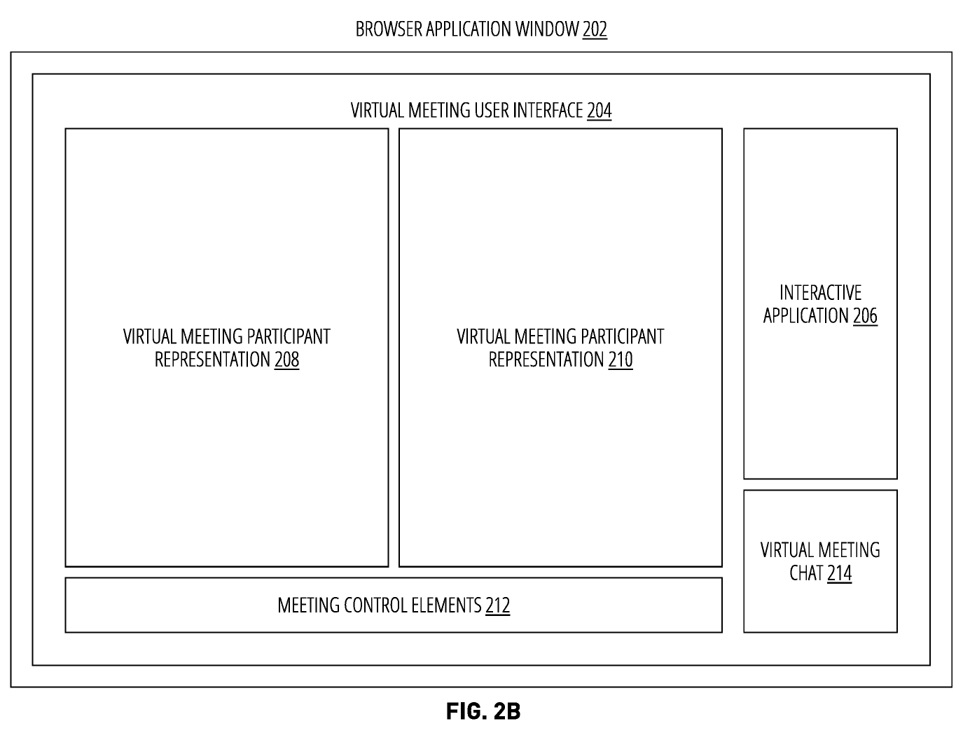

As an example, using browser application 104a of client device 102a, a user can navigate to a virtual meeting application provided by virtual meeting server 110 (e.g., virtual meeting with interactive application 106a) and initiate or join a virtual meeting. Browser application 104a can render a user interface (UI) corresponding to the virtual meeting (see FIG. 2A and FIG. 2B). Based on one or more user interactions, a second application (e.g., an application different than the virtual meeting application) can be embedded into the virtual meeting and rendered within the virtual meeting UI.

In some embodiments, content from the application is rendered within the virtual meeting UI. The content can include, for example, a document, an image, a video, an audio, a web page, software code, etc. A virtual meeting participant that adds the application to the virtual meeting can select content of the application to present to the one or more virtual meeting participants. For example, the application may be a collaborative document drafting application. The virtual meeting participant that adds the application can choose a first document (e.g., content of the application) to be rendered within the virtual meeting UI. In some embodiments, the virtual meeting participant that adds content of an application to a virtual meeting can provide other meeting participants’ access to the content of the application for a predefined period of time. For example, a document may be embedded within the application, and the document may have associated access controls that prevent others from viewing and/or editing the document. The virtual meeting participant that embeds the document can grant access to the other participants of the virtual meeting to allow them to access (e.g., view, edit, etc.) the document. The access may be granted for the duration of the virtual meeting, for a fixed time period (e.g., the next 12 hours, the next 24 hours, etc.).

The embedded application can allow for real time (or near real time) multi-user content collaboration between the virtual meeting participants. For example, a first state of the application (or of content of the application) can be presented (e.g., rendered) within the virtual meeting UI. After a user interaction (e.g., by the first user, by another user, etc.), a second state of the application (or of content of the application) can be presented (e.g., rendered) within the virtual meeting UI.

In some embodiments, the application is embedded in the virtual meeting UI using a HyperText Markup Language (HTML) iframe element.

In some embodiments, the embedded application can be created and/or provided by a provider of the virtual meeting service. In some embodiments, the embedded application can be created and/or provided by a third-party service.

In some embodiments, the virtual meeting UI can include representations (e.g., thumbnails, video clips, text descriptions, etc.) of one or more compatible applications that can be embedded within the virtual meeting. Virtual meeting server 110 can provide (e.g., from application repository 112) the representations of one or more compatible applications that can be embedded within the virtual meeting. In some embodiments, based on a user interaction with one of the representations, a corresponding application can be embedded within the virtual meeting.

In some embodiments, an application needs to be installed within the browser application (e.g., browser application 104a, browser application 104b, etc.) before a virtual meeting participant can interact with an embedded application. In some embodiments, the application can require a minimum browser application version in order to be installed in the browser application. In some embodiments, the application needs to be configured (e.g., granted one or more permissions, linked to an account, etc.) before it can be used to interact with an embedded application. In some embodiments, a user can be prompted to install the application required for interaction with an embedded application when a user tries interacting with an embedded application. For example, after a virtual meeting participant receives a notice that another virtual meeting participant has embedded an application within the virtual meeting, the browser application of the virtual meeting participant can determine whether an application corresponding to the embedded application is present in the virtual meeting client running in the virtual meeting participant's browser. If the application corresponding to the embedded application is present in the virtual meeting client, the embedded application can be rendered within the virtual meeting UI (e.g., presented within a frame of the virtual meeting UI). If the application corresponding to the embedded application is not present in the virtual meeting client, the browser application can determine if the application corresponding to the embedded application is compatible with the browser application. If the application corresponding to the embedded application is compatible, a prompt can be provided to the virtual meeting participant asking if they would like to add (e.g., install) the application corresponding to the embedded application to their browser application. Responsive to the virtual meeting participant answering affirmatively, the application corresponding to the embedded application can be added to the browser application of the virtual meeting participant, and the embedded application can be rendered within the virtual meeting UI (e.g., presented within a frame of the virtual meeting UI using an iframe element).

In some embodiments, during a virtual meeting, a user can navigate within browser application 104a of client device 102a to an application they would like to be embedded within the virtual meeting. For example, the virtual meeting and corresponding virtual meeting UI can be running in a first tab of browser application 104a and the user can navigate to an application they would like to be embedded within the virtual meeting in a second tab of browser application 104a. From the second browser tab of browser application 104a, the user can share the application and cause it to be embedded within the virtual meeting of the first browser tab. In some embodiments, the application in the second browser tab can detect that a virtual meeting is taking place and can provide the user an option to embed the application into the virtual meeting.

In some embodiments, a user can navigate to an application in a second tab of browser application 104a. A user may start a screen share of that tab, causing a non-interactive visual representation of the application in the second tab of browser application 104a to be shared with other meeting participants. During the screen share, if the application in the second tab of browser application 104a is able to be embedded within the virtual meeting, the user can be prompted to “upgrade” the screen share to become an embedded application. For example, after clicking on an option to make the screen share interactive, information about the application can be provided to the client devices of the other meeting participants and an embedded version of the application can be added to the virtual meeting user interface of each client device, as discussed herein.

In some embodiments, after a user interaction causing an application to be embedded within the virtual meeting, information about the application can be transmitted to one or more other participant devices (e.g., via network 108 and virtual meeting server 110). In some embodiments, virtual meeting server 110 includes virtual meeting state management subsystem 114 to manage a state of virtual meetings and to track embedded applications. For example, virtual meeting state management subsystem 114 can track which participants are in a virtual meeting. Once a participant embeds an application within the virtual meeting, virtual meeting state management subsystem 114 can track information about the application (e.g., a uniform resource locator (URL) of the application, a name of the application, a position of the application within the virtual meeting UI, etc.). The browser application of the virtual meeting participant can receive heartbeat data from the embedded application, which can indicate if the embedded application is responsive and working correctly. If the heartbeat data indicates the embedded application is no longer working (e.g., if the heartbeat data is no longer being transmitted by the embedded application), virtual meeting state management subsystem 114 can be updated to indicate that the embedded application is no longer being shared within the virtual meeting. In some embodiments, if the heartbeat data is no longer being transmitted by the embedded application, a prompt can be displayed to the user to allow the user to try connecting to the embedded application again.

Virtual meeting state management subsystem 114 can also track which users are interacting with the embedded application. For example, after a first user (e.g., first virtual meeting participant) causes an application to be embedded within a virtual meeting, information regarding the application can be provided to client devices of other participants of the virtual meeting. The other participant can receive, for example, a description, screenshot, or other representation of the embedded application, which can be rendered in the virtual meeting UI of the other participant. The other participant's virtual meeting UI can provide a prompt (e.g., a dialog, a message, etc.) asking if the other participant would like to interact with the embedded application. If the other participant answers affirmatively, the application (e.g., an instance of the application) can be embedded within the virtual meeting UI of the other participant, and the other participant can begin interacting with the embedded application. In some embodiments, the other participant may need an application installed in their browser application before they can interact with the embedded application. Interactions of the other participant can appear in the first participant's virtual meeting UI in the embedded app in real-time (or near real-time), and vice versa. Virtual meeting state management subsystem 114 can track that the other participant has begun interacting with the embedded application. In some embodiments, information related to embedded applications can be tracked by a third-party. For example, if a music playback application is embedded in a virtual meeting, the music playback service provider may track a state of the embedded application.

If the other participant indicates they do not want to interact with the embedded application, instead of embedding the application within the virtual meeting UI of the other participant, a non-interactive visual representation (e.g., screenshot, screen recording, etc.) of the application can be included in the virtual meeting UI of the other participant. For example, a message (e.g., data packet, etc.) can be provided from the other participant's browser application to the first participant's browser application (e.g., via virtual meeting server 110) requesting that a visual representation of the embedded application be provided from the first participant's browser application. The visual representation from the first participant can be included in the virtual meeting UI of the other participant, which can allow the other participant to see what is taking place within the embedded application in the virtual meeting without interacting with the application. Virtual meeting state management subsystem 114 can track that the other participant denied interacting with the embedded application.

In some embodiments, when embedding an application within a virtual meeting, a first virtual meeting participant can be presented with a prompt (e.g., message, dialog, etc.) asking if they want to invite other virtual meeting participants to interact with the application. If the first virtual meeting participant answers affirmatively, the embedded application information can be shared with other virtual meeting participants (e.g., a message from the browser application of the first virtual meeting participant can send a message (e.g., data packet, etc.) to the browser application of one or more other virtual meeting participants), as described above. If the first virtual meeting participant does not want to invite other virtual meeting participants to interact with the application, the application can be embedded within the virtual meeting UI of the first virtual meeting participant without also being embedded within the virtual meeting UIs of other virtual meeting participants.

In some embodiments, if the first virtual meeting participant does not want to invite other virtual meeting participants to interact with the application, the first virtual meeting participant can be prompted asking if they want other virtual meeting participants to be able to see the embedded application without being able to interact with it. If the first virtual meeting participant answers affirmatively, a non-interactive visual representation of the embedded application can be shared with the other virtual meeting participants and can be included in their respective virtual meeting UIs, as described above.

In some embodiments, as discussed above, application repository 112 can include information about one or more applications that can be embedded within a virtual meeting. The information can be provided to one or more virtual meeting participants (e.g., via the virtual meeting application running in the virtual meeting participant's browser application) that want an application to be embedded within a virtual meeting. In some embodiments, a virtual meeting participant can cause embedding within a virtual meeting of an application (e.g., application 116) that is not included in application repository 112.

In some embodiments, more than one application can be embedded within a virtual meeting. For example, a first virtual meeting participant can request to embed a first application within a virtual meeting, and a second virtual meeting participant can request to embed a second application within the same virtual meeting. In some embodiments, a first virtual meeting participant can request to embed a first application and a second application within a virtual meeting. As discussed above, the embedded application can be included in a primary section of the virtual meeting UI or in a sidebar of the virtual meeting UI. When more than one application is embedded within the virtual meeting, a first application can be included in the primary section of the virtual meeting UI while a second application is included in a sidebar of the virtual meeting UI.

In some embodiments, more than one embedded application can be included in the primary section of the virtual meeting UI and/or in the sidebar of the virtual meeting UI. For example, a first part of the primary section and/or sidebar (e.g., 50%, 30%, etc.) can show a first embedded application while a second part of the primary section and/or sidebar (e.g., 50%, 70%, etc.) can show a second embedded application.

In some embodiments, the embedded application is an application that allows more than one user to interact and/or collaborate at a time. For example, the embedded application can be a shared whiteboard app, a collaborative design app (e.g., for website design, document design, etc.), a video game app (e.g., ice breaker game, board game, card game, etc.), a collaborative document drafting app, a note taking app, and/or a remote technical support app.

In implementations of the disclosure, a “user” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether virtual meeting server 110 collects user information (e.g., information about a user’s social network, social actions or activities, profession, a user’s preferences, or a user’s current location), or to control whether and/or how to receive content from virtual meeting server 110 that can be more relevant to the user. In addition, certain data can be treated in one or more ways before it is stored or used, so that personally identifiable information is removed. For example, a user’s identity can be treated so that no personally identifiable information can be determined for the user, or a user’s geographic location can be generalized where location information is obtained (such as to a city, ZIP code, or state level), so that a particular location of a user cannot be determined. Thus, the user can have control over how information is collected about the user and used by virtual meeting server 110.

FIG. 2A depicts a first view of a virtual meeting user interface 204, in accordance with one embodiment. Virtual meeting user interface 204 can be included in browser application window 202. For example, a browser application can render virtual meeting user interface 204 in a first tab of browser application window 202. Virtual meeting user interface 204 can include one or more elements related to a virtual meeting, such as interactive application 206, virtual meeting participant representation 208, virtual meeting participant representation 210, meeting control elements 212, and/or virtual meeting chat 214. In some embodiments, interactive application 206 can be included in a primary section of virtual meeting user interface 204, as shown, while virtual meeting participant representation 208, virtual meeting participant representation 210, and virtual meeting chat 214 are included in a side bar of virtual meeting user interface 204.

Interactive application 206 can include an application embedded in the virtual meeting. User interactions with interactive application 206 and/or its content can be provided to the application and can modify a state of the application and/or its content.

Virtual meeting participant representation 208 and virtual meeting participant representation 210 can include representations of virtual meeting participants. For example, virtual meeting participant representation 208 can include a visual representation (e.g., a picture, a live video, a video clip, etc.) or a textual representation (e.g., name, initials, title, etc.) of a first virtual meeting participant. In some embodiments, virtual meeting participant representation 208 can depict the user of browser application window 202. In some embodiments, virtual meeting participant representation 208 can depict another virtual meeting participant.

Meeting control elements 212 can include one or more elements to allow a user to interact with the virtual meeting. For example, meeting control elements 212 can include a mute button, a camera on/off button, a share screen button, a stop screen share button, an embed application button, a stop embedding application button, a stop virtual meeting button, a virtual reaction button (e.g., to virtually raise a hand, applaud, laugh, etc.), and/or the like. In some embodiments, one or more participants can communicate using text within virtual meeting user interface 204 via virtual meeting chat 214.

FIG. 2B depicts a second view of a virtual meeting user interface 204, in accordance with one embodiment. In FIG. 2B, interactive application 206 is depicted in the sidebar of virtual meeting user interface 204, while virtual meeting participant representation 208 and virtual meeting participant representation 210 are depicted in the primary section of virtual meeting user interface 204. As depicted in FIG. 2B, the primary section of virtual meeting user interface 204 can be divided into one or more parts. In some embodiments, a first embedded application can be included in a first part of the primary section of virtual meeting user interface 204 (e.g., corresponding to the region covered by virtual meeting participant representation 208 in FIG. 2B) and a second embedded application can be included in a second part of the primary section of virtual meeting user interface 204 (e.g., corresponding to the region covered by virtual meeting participant representation 210 in FIG. 2B).

In some embodiments, a user can move elements of virtual meeting user interface 204 from one position to another during a virtual meeting. For example, interactive application 206 may start in the primary section of virtual meeting user interface 204 (e.g., as depicted in FIG. 2A), and based on one or more user interactions (e.g., clicking a button, dragging the interactive application 206, pressing one or more keys on a keyboard, etc.), interactive application 206 may be moved to the sidebar of virtual meeting user interface 204 (e.g., as depicted in FIG. 2B).

In some embodiments, the primary section of virtual meeting user interface 204 can include a combination of virtual meeting participant representations and embedded applications. For example, the primary section of virtual meeting user interface 204 can include one virtual meeting participant representation side-by-side with an embedded application.

In some embodiments, virtual meeting user interface 204 can include one or more representations (e.g., images, video clips, text descriptions, etc.) of applications that can be embedded within the virtual meeting.

In some embodiments, a virtual meeting UI rendered on a first participant's device can be different than a virtual meeting UI rendered on a second participant's device. For example, a first virtual meeting participant can have the embedded application of the virtual meeting in the primary section of the virtual meeting UI rendered on their device, while a second virtual meeting participant has the embedded application of the virtual meeting in the sidebar of the virtual meeting UI. As another example, a first virtual meeting participant may have an embedded application in the sidebar of the virtual meeting UI presented on their device, and a second virtual meeting participant may not have any embedded application included in the virtual meeting UI presented on their device.

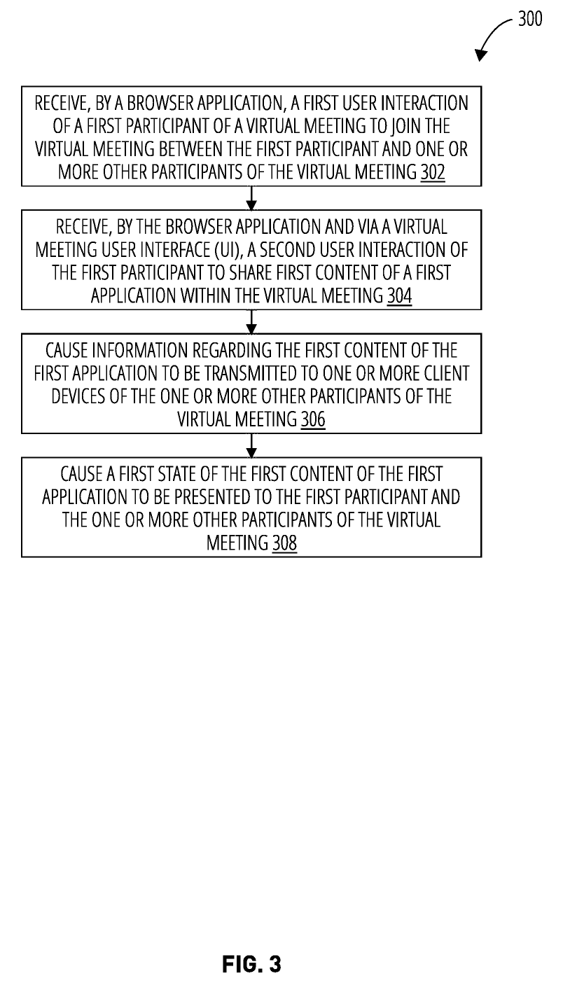

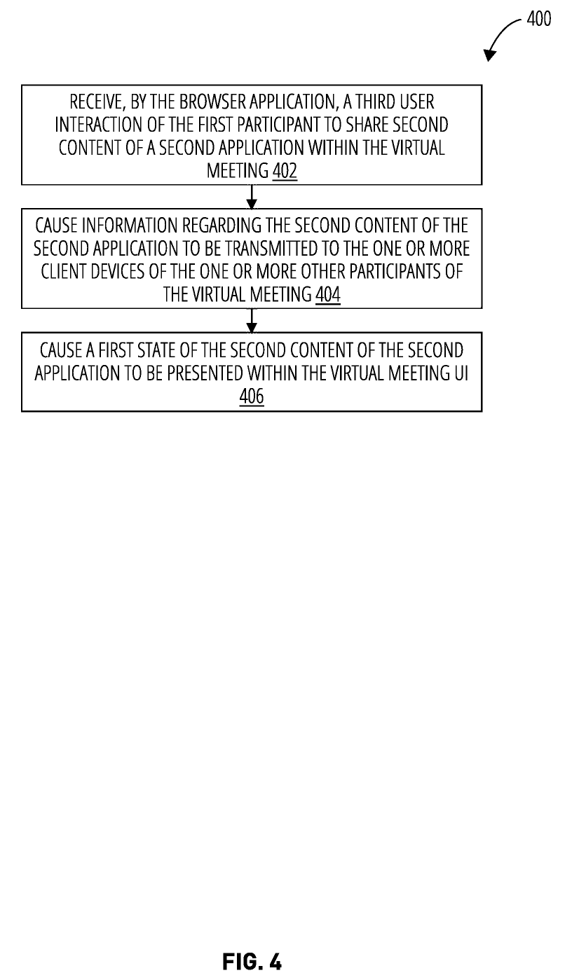

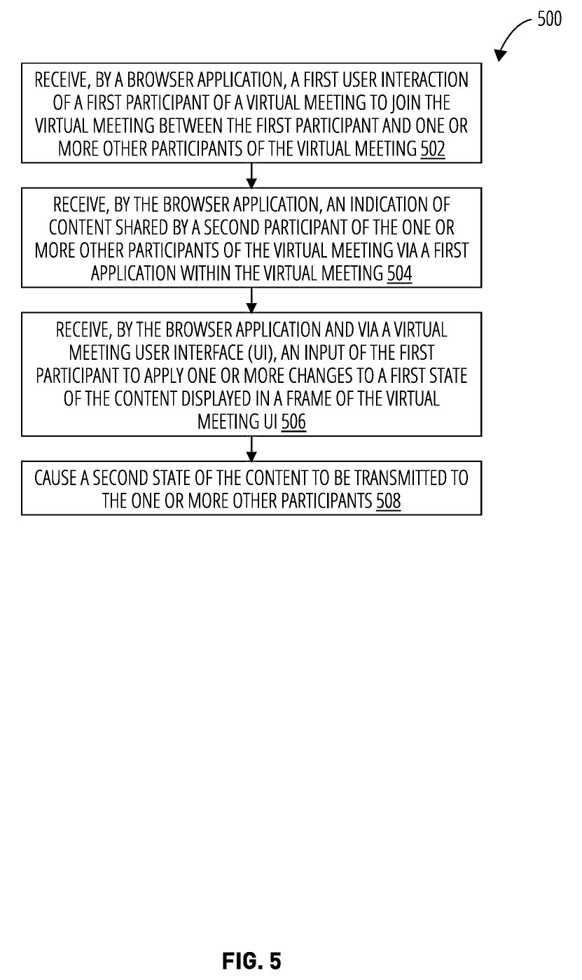

FIG. 3 depicts a flow diagram of an example method 300 for embedding applications in virtual meetings, in accordance with at least one embodiment. FIG. 4 depicts a flow diagram of an example method 400 for embedding applications in virtual meetings, in accordance with one embodiment. FIG. 5 depicts a flow diagram of an example method 500 for modifying content of an embedded application in a virtual meeting, in accordance with one embodiment. Method 300, method 400, and/or method 500 can be performed by processing logic that can include hardware (circuitry, dedicated logic, etc.), software (e.g., instructions run on a processing device), or a combination thereof. In at least one implementation, some or all of the operations of method 300, method 400, and/or method 500 can be performed by one or more components of system 100 for enabling real time multi-user content collaboration in virtual meetings of FIG. 1. For example, in some embodiments, method 300, method 400, and/or method 500 can be performed by browser application 104a or browser application 104b of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Referring to FIG. 3, at block 302, processing logic can receive, by a browser application, a first user interaction of a first participant of a virtual meeting to join a virtual meeting between the first participant and one or more other participants of the virtual meeting. At block 304, processing logic can receive, by the browser application and via a virtual meeting user interface (UI), a second user interaction of the first participant to share first content of a first application within the virtual meeting. In some embodiments, the first application includes at least one of a shared whiteboard application, a collaborative design application, a video game application, a collaborative document drafting application, a note taking application, or a remote technical support application. For example, the first content of the first application can be an editable document, chat messages, notes related to the virtual meeting, and/or the like.

In some embodiments, to receive the second user interaction of the first participant to share the first content of the first application within the virtual meeting, processing logic can present information related to a plurality of applications that facilitate content collaboration during the virtual meeting. The information related to the plurality of applications can be stored in and provided by an application repository (e.g., application repository 112 of FIG. 1). The information can include one or more textual descriptions and/or visual representations of applications that can be embedded within a virtual meeting.

Processing logic can further receive user selection of the first application from the plurality of applications. Processing logic can further receive user selection of the first content of the first application. Processing logic can further receive user confirmation to grant access to the first content for the one or more other participants over a predefined time period.

At block 306, processing logic can cause information regarding the first content of the first application to be transmitted to one or more client devices of the one or more other participants of the virtual meeting. At block 308, processing logic can cause a first state of the first content of the first application to be presented to the first participant and the one or more other participants of the virtual meeting. For example, the first state of the first content of the first application can include a first page of a document or a first version of the document.

In some embodiments, to cause the first state of the first content of the first application to be presented to the first participant and the one or more other participants of the virtual meeting, processing logic can cause a visual representation of the first state of the first content of the first application to be transmitted to the one or more client devices of the one or more other participants of the virtual meeting.

In some embodiments, processing logic can receive a second state of the first content of the first application from a second client device of a second participant of the one or more other participants of the virtual meeting and can cause the second state of the first content of the first application to be presented to the first participant. In some embodiments, the second state of the first content can reflect one or more changes to the first content by the second participant. For example, the second participant may modify the document by adding or removing content and making a second version of the document. The second state of the first content of the first application can include the second version of the document.

In some embodiments, processing logic can cause a visual representation of the first content of the first application to be transmitted to at least a first client device of the one or more client devices of the one or more other participants of the virtual meeting. For example, if a virtual meeting participant does not want to interact with the application but wants to see the application, a visual representation (e.g., screenshot, screen recording, etc.) can be transmitted from the client device that embedded the application into the virtual meeting to a client device of another virtual meeting participant.

In some embodiments, processing logic can receive, by the browser application, heartbeat data of the first application within a first time period, and responsive to failing to receive the heartbeat data within a second time period during the virtual meeting, cause a corrective action to be performed with respect to the first application. In some embodiments, the corrective action can include reloading the first application, removing the first application from the virtual meeting, presenting a message to the one or more virtual meeting participants indicating a problem with the first application, presenting a message to the one or more virtual meeting participants with troubleshooting steps for a virtual meeting participant to take, and/or the like. For example, the first application can send heartbeat data to the browser application to indicate a state of the first application. If a problem occurs with the first application, the heartbeat data can stop being transmitted to the browser application, and the browser application can stop embedding the first application within the virtual meeting.

Referring to FIG. 4, in some embodiments, method 400 can be performed following method 300. At block 402, processing logic can receive, by the browser application, a third user interaction of the first participant to share second content of a second application within the virtual meeting. At block 404, processing logic can cause information regarding the second content of the second application to be transmitted to the one or more client devices of the one or more other participants of the virtual meeting. At block 406, processing logic can cause a first state of the second content of the second application to be presented within the virtual meeting UI.

Referring to FIG. 5, at block 502, processing logic can receive, by a browser application, a first user interaction of a first participant of a virtual meeting to join the virtual meeting between the first participant and one or more other participants of the virtual meeting. At block 504, processing logic can receive, by the browser application, an indication of content shared by a second participant of the one or more other participants of the virtual meeting via a first application within the virtual meeting. For example, the second participant may cause the first application to be embedded within the virtual meeting. The first participant can receive a notice that the second participant has embedded an application, and the first participant can be given the opportunity to interact with the application embedded by the second participant. In some embodiments, the first participant can see the application embedded by the second participant (or a visual representation thereof) without interacting with the embedded application.

In some embodiments, processing logic can determine, upon receiving the indication of the content shared by the second participant via the first application within the virtual meeting, whether the first application is present in a virtual meeting client running in the browser application. Responsive to determining that the first application is present in the virtual meeting client running in the browser application, processing logic can cause the first application to be associated with the frame of the virtual meeting UI. Alternatively, responsive to determining that the first application is not present in the virtual meeting client running in the browser application, processing logic can determine whether the first application is compatible with the browser application. Processing logic can further, responsive to determining that the first application is compatible with the browser application, cause the first application to be associated with the frame of the virtual meeting UI.

At block 506, processing logic can receive, by the browser application and via a virtual meeting user interface (UI), an input of the first participant to apply one or more changes to a first state of the content displayed in the frame of the virtual meeting UI. At block 508, processing logic can cause a second state of the content to be transmitted to the one or more other participants. In some embodiments, the second state reflects the one or more changes to the content by the first participant.

In some embodiments, processing logic can receive a third state of the content of the first application from a second client device of the second participant of the one or more other participants of the virtual meeting. In some embodiments, the third state reflects one or more changes to the content by the second participant. Processing logic can further cause the third state of the content of the first application to be presented to the first participant.

FIG. 6 is a block diagram illustrating an exemplary computer system, in accordance with at least one embodiment of the present disclosure. The computer system 600 can correspond to client device 102a and/or client device 102b, described with respect to FIG. 1. The computer system 600 can also correspond to devices virtual meeting server 110, described with respect to FIG. 1. Computer system 600 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 616, which communicate with each other via a bus 628.

Processor (processing device) 602 represents one or more general-purpose processing devices such as a microprocessor, central processing unit, or the like, and may include processing logic 622. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 is configured to execute instructions 626 (e.g., for generating threat indicator alerts) for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 618 (e.g., a speaker). In some embodiments, computer system 600 may not include video display unit 610, input device 612, and/or cursor control device 614 (e.g., in a headless configuration).

The data storage device 616 can include a non-transitory machine-readable storage medium 624 (also computer-readable storage medium) on which is stored one or more sets of instructions 626 (e.g., for enabling real time multi-user content collaboration in virtual meetings) embodying any one or more of the methodologies or functions described herein. The instructions 626 can also reside, completely or at least partially, within the main memory 604 and/or within the processor 602 during execution thereof by the computer system 600, the main memory 604 and the processor 602 also constituting machine-readable storage media. The instructions can further be transmitted or received over a network 620 via the network interface device 608.

In one implementation, the instructions 626 include instructions for enabling real time multi-user content collaboration in virtual meetings. While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving, by a browser application, a first user interaction of a first participant of a virtual meeting to join the virtual meeting between the first participant and one or more other participants of the virtual meeting;
receiving, by the browser application and via a virtual meeting user interface (UI), a second user interaction of the first participant to share first content of a first application within the virtual meeting;
causing information regarding the first content of the first application to be transmitted to one or more client devices of the one or more other participants of the virtual meeting; and
causing a first state of the first content of the first application to be presented to the first participant and the one or more other participants of the virtual meeting.

2. The method of claim 1, further comprising:
receiving a second state of the first content of the first application from a second client device of a second participant of the one or more other participants of the virtual meeting, wherein the second state reflects one or more changes to the first content by the second participant; and
causing the second state of the first content of the first application to be presented to the first participant.

3. The method of claim 1, further comprising:
receiving, by the browser application, a third user interaction of the first participant to share second content of a second application within the virtual meeting;
causing information regarding the second content of the second application to be transmitted to the one or more client devices of the one or more other participants of the virtual meeting; and
causing a first state of the second content of the second application to be presented within the virtual meeting UI.

4. The method of claim 1, wherein causing the first state of the first content of the first application to be presented to the first participant and the one or more other participants of the virtual meeting further comprises causing a visual representation of the first state of the first content of the first application to be transmitted to the one or more client devices of the one or more other participants of the virtual meeting.

5. The method of claim 1, wherein receiving the second user interaction of the first participant to share the first content of the first application within the virtual meeting comprises:
presenting information related to a plurality of applications that facilitate content collaboration during the virtual meeting;
receiving user selection of the first application from the plurality of applications;
receiving user selection of the first content of the first application; and
receiving user confirmation to grant access to the first content for the one or more other participants over a predefined time period.

6. The method of claim 1, further comprising:
receiving, by the browser application, heartbeat data of the first application within a first time period; and
responsive to failing to receive the heartbeat data within a second time period during the virtual meeting, causing a corrective action to be performed with respect to the first application.

7. The method of claim 1, wherein the first application comprises at least one of:
a shared whiteboard application;
a collaborative design application;
a video game application;
a collaborative document drafting application;
a note taking application; or
a remote technical support application.

8. A system comprising:
a memory device; and
a processing device coupled to the memory device, the processing device to perform operations comprising:
receiving, by a browser application, a first user interaction of a first participant of a virtual meeting to join the virtual meeting between the first participant and one or more other participants of the virtual meeting;
receiving, by the browser application and via a virtual meeting user interface (UI), a second user interaction of the first participant to share first content of a first application within the virtual meeting;
causing information regarding the first content of the first application to be transmitted to one or more client devices of the one or more other participants of the virtual meeting; and
causing a first state of the first content of the first application to be presented to the first participant and the one or more other participants of the virtual meeting.

9. The system of claim 8, the operations further comprising:
receiving a second state of the first content of the first application from a second client device of a second participant of the one or more other participants of the virtual meeting, wherein the second state reflects one or more changes to the first content by the second participant; and
causing the second state of the first content of the first application to be presented to the first participant.

10. The system of claim 8, the operations further comprising:
receiving, by the browser application, a third user interaction of the first participant to share second content of a second application within the virtual meeting;
causing information regarding the second content of the second application to be transmitted to the one or more client devices of the one or more other participants of the virtual meeting; and
causing a first state of the second content of the second application to be presented within the virtual meeting UI.

11. The system of claim 8, wherein causing the first state of the first content of the first application to be presented to the first participant and the one or more other participants of the virtual meeting further comprises causing a visual representation of the first state of the first content of the first application to be transmitted to the one or more client devices of the one or more other participants of the virtual meeting.

12. The system of claim 8, wherein receiving the second user interaction of the first participant to share the first content of the first application within the virtual meeting comprises:
presenting information related to a plurality of applications that facilitate content collaboration during the virtual meeting;
receiving user selection of the first application from the plurality of applications;
receiving user selection of the first content of the first application; and
receiving user confirmation to grant access to the first content for the one or more other participants over a predefined time period.

13. The system of claim 8, further comprising:
receiving, by the browser application, heartbeat data of the first application within a first time period; and
responsive to failing to receive the heartbeat data within a second time period during the virtual meeting, causing a corrective action to be performed with respect to the first application.

14. The system of claim 8, wherein the first application comprises at least one of:
a shared whiteboard application;
a collaborative design application;
a video game application;
a collaborative document drafting application;
a note taking application; or
a remote technical support application.

15. A method comprising:
receiving, by a browser application, a first user interaction of a first participant of a virtual meeting to join the virtual meeting between the first participant and one or more other participants of the virtual meeting;
receiving, by the browser application, an indication of content shared by a second participant of the one or more other participants of the virtual meeting via a first application within the virtual meeting;
receiving, by the browser application and via a virtual meeting user interface (UI), an input of the first participant to apply one or more changes to a first state of the content displayed in a frame of the virtual meeting UI, wherein the frame of the virtual meeting UI is associated with the first application; and
causing a second state of the content to be transmitted to the one or more other participants, wherein the second state reflects the one or more changes to the content by the first participant.

16. The method of claim 15, further comprising:
upon receiving the indication of the content shared by the second participant via the first application within the virtual meeting, determining whether the first application is present in a virtual meeting client running in the browser application; and
responsive to determining that the first application is present in the virtual meeting client running in the browser application, causing the first application to be associated with the frame of the virtual meeting UI.

17. The method of claim 16, further comprising:
responsive to determining that the first application is not present in the virtual meeting client running in the browser application, determining whether the first application is compatible with the browser application; and
responsive to determining that the first application is compatible with the browser application, causing the first application to be associated with the frame of the virtual meeting UI.

18. The method of claim 15, further comprising:
receiving a third state of the content of the first application from a second client device of the second participant of the one or more other participants of the virtual meeting, wherein the third state reflects one or more changes to the content by the second participant; and
causing the third state of the content of the first application to be presented to the first participant.

19. The method of claim 15, further comprising:
receiving, by the browser application, heartbeat data of the first application within a first time period; and
responsive to failing to receive the heartbeat data within a second time period during the virtual meeting, causing a corrective action to be performed with respect to the first application.

20. The method of claim 15, wherein the first application comprises at least one of:
a shared whiteboard application;
a collaborative design application;
a video game application;
a collaborative document drafting application;
a note taking application; or
a remote technical support application.
